(19) United States
(12) Patent Application Publication
(10) Pub. No.: US 2006/0168003 A1
(43) Pub. Date: Jul. 27, 2006

(54) Method for archiving multimedia messages

(76) Inventors: Jena-Marie Vau, Paris (FR); Joachim Moelle, Neuss NRW (DE); Olivier A. Furon, Paris (FR); Olivier M. Rigault, La Celle St Cloud (FR)

Correspondence Address: PATENT LEGAL STAFF, EASTMAN KODAK COMPANY, 343 STATE STREET, ROCHESTER, NY, 14650-2201, US

(21) Appl. No.: 10/528,981

(22) PCT Filed: Sep. 8, 2003
(86) PCT No.: PCT/EP03/09924

§ 371 Date: Mar. 23, 2005

(30) Foreign Application Priority Data
Sep. 23, 2002 (FR) 02/11751

(51) Int. Cl. G06F 15/16

(52) U.S. Cl. 709/206

(57) ABSTRACT

The present invention is in the technical field of imaging. It is used in digital networks to communicate and to archive multimedia messages. The invention relates to a method enabling the communication of at least one multimedia message between at least two terminals (3), (4) located in a digital network comprising two data servers (1), (2), each data server (1), (2) comprising at least one user data base (16), (22) and a digital data storage means (15), (21), said method being characterized in that it enables multimedia messages to be synchronized and archived between the two data servers (1), (2). The invention method is implemented in multimedia applications using in particular portable terminals.

### FIELD OF THE INVENTION

The present invention is in the technical field of imaging. It is used in digital networks comprising servers, to communicate and to archive multimedia messages.

### BACKGROUND OF THE INENTION

The communication of digital data in the Internet (web), in an interactive way, using servers, is known in the prior art. U.S. Pat. No. 6,341,316 describes a method, a system and a computer program, to transmit to a client terminal, information collected and maintained on a web server, for example by a service provider. The client terminal is for example a PDA (Personal Data Assistant). A synchronization is carried out between the server and the client terminal.

U.S. Patent applications 2002/0046296 and 2002/0052916 are divisional applications of the above-mentioned U.S. Pat. No. 6,341,316. U.S. Patent application 2002/0046296 describes a method to start the synchronization process between the client terminal and the server. US Patent application 2002/0052916 describes a method to create and add automatically in a data base of the client terminal, links (web sites) corresponding to the specific requests of the user of the client terminal.

Servers are key components of digital data transmission networks. Given the high number of exchanges or message communications that can be carried out, in a short period of time, between multiple network terminals, the problem confronting users of these mobile terminals, relates to the interactivity of the message communication, from these terminals. This responsiveness is an important parameter for the communication of multimedia messages that include a large amount of digital data The interactivity of the communication of messages exchanged between two terminals involves good synchronization of the flows of digital data forming these messages, during their transport in the network. Poor synchronization means waiting times for terminal users. These waiting times are due for example to the temporary unavailability of the recipient terminal, or the temporary unavailability of a central server storing the digital data and located between a message sending terminal and a recipient terminal for this message. To solve this problem, the operators of digital network servers attempt to find a technical compromise so as not to penalize all the users, by enabling the temporary archiving in a server, of messages transiting between mobile terminals. The temporary archiving is for example two days after receipt of the sent message in the server; and then, after this time, the message is automatically destroyed, to free the storage capacity in said server. This message destruction is a disadvantage for the message recipient, who for example has not reacted immediately to an automatic notification telling them that they have received this message; thus they can no longer read the message (destroyed) on their terminal.

Terminals, especially portable terminals, are increasingly used to exchange messages. The storage and reading capacities of these terminals are increasing; thus the data flows communicated between these terminals are increasingly difficult to manage by the central servers of the networks that are overloaded. These servers become bottlenecks that penalize the terminal user, because the waiting times are inconvenient, or the information initially sent is lost, because it is destroyed after temporary archiving.

### SUMMARY OF THE INVENTION

It is an object of the present invention to provide a method that enables the problem of the temporary archiving of a message to be solved. The invention method enables the synchronization, without risk of data loss, of the communication of multimedia messages between two servers. These multimedia messages are exchanged between terminals that communicate, in a digital network, with the two servers. These multimedia messages comprise one or more images, text messages, or even voice or audio messages.

It is an object of the present invention to provide a method enabling the communication of at least one multimedia message between at least two terminals located in a digital network comprising two data servers; each data server comprises at least one user data base and a digital data storage means; the invention method is characterized in that it consists in the synchronizing and archiving of the multimedia message between the two servers; by automatically carrying out the following steps:
a) from at least one multimedia message sent from a first terminal and intended to be sent to a recipient address of a second terminal, the contents of said multimedia message being temporarily saved in the first data server, determine a subscription identifier to a recipient's archiving service, the archiving service being specific to the second server;
b) associate the recipient address with the subscription identifier to the archiving service of said recipient;
c) send the contents of the multimedia message from the first server to the second server;
d) archive the contents of the multimedia message in the second server.

According to a variant, the invention method also comprises an automatic extraction of a part of the contents of the multimedia message, before its archiving.

According to another variant, the invention method also comprises an automatic reformatting of the archived multimedia message, to enhance it with additional data.

Other characteristics and advantages will appear on reading the following description, with reference to the drawings of the various figures.

### BRIEF DESCRIPTION OF THE DRAWINGS

FIG. 1 represents an overall environment that diagrammatically shows a multimedia message distribution network.

FIG. 2 represents a diagrammatical structure of a network for implementing the invention method.

### DETAILED DESCRIPTION OF THE INVENTION

The following description is a detailed description of the main embodiments of the invention, with reference to the drawings in which the same numerical references identify the same elements in each of the different figures.

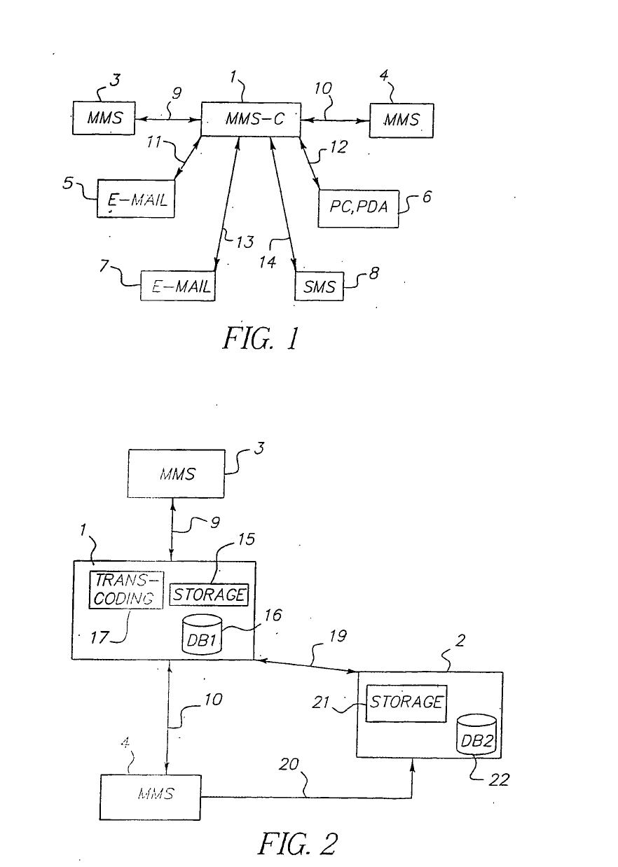

Messaging services, like SMS (Short Message Service) or MMS (Multimedia Message Service) are used in digital networks to exchange messages comprising either text alone, or text combined with digital images, these messages also being capable of containing audio data. These SMS or MMS messaging services can be applied by using a terminal equipped with a display screen and capable of being connected to a network, for example the Internet. These messaging services are used advantageously with mobile terminals, for example a cellphone. FIG. 1 diagrammatically represents an overall digital network environment, in which several terminals 3, 4, 5, 6, 7 and 8 inter-communicate, using at least one data server 1, through links 9, 10, 11, 12, 13 and 14. These terminals can be message senders or receivers respectively. The messages transit by the central server 1, which is for example a messaging server, and in which these messages can be stored temporarily, after their sending from the sending terminal, and before their reception by the recipient terminal. The link 14 is for example a wireless link enabling SMS type messages comprising text messages only to be communicated to the terminal 8; the terminal 8 does not have the display capacity to enable an image to be displayed. The links 11 and 12 are for example cable links enabling messages to be communicated using protocols of the type HTTP (Hyper Text Transmission Protocol) or SMTP (Simple Mail Transfer Protocol) with the terminals 5 and 6 respectively; the terminal 6 is for example a PC (Personal Computer) or a PDA (Personal Digital Assistant). SMTP enables for example multimedia messages to be sent, by the link 11, for example to an e-mail address, at the terminal 5. The links 9 10, 13 and 14 are for example WAP (Wireless Application Protocol) type links. These wireless links enable the communication of messages of the type SMS, e-mail, or MMS, for example to terminals 3, 4, 7 and 8. These wireless links are for example of the type GSM (Global System for Mobile) or GPRS (General Packet Radio System). The terminals 3 and 4 are for example portable cellphones enabling the display of multimedia messages comprising color images; the portable terminal 3 or 4 also has a memory capacity enabling the storage of a series of images or multimedia messages in the form of a photographic album called a portable album.

The new mobile terminals 3 or 4 can be for example camera-telephone platforms, enabling the capture of digital images to which text messages or voice messages are associated. These new mobile terminals have increased their capacity, which enables the correct display of colors in images; these new mobile terminals have also increased their capacity to store or save images in the form for example of a portable album. The image, text and/or voice message assembly is a multimedia message. The multimedia message comprises one or more still or animated images, these images can be for example displayed in black and white or in color on the screen of a portable terminal 3 or 4.

According to FIG. 2 which represents the diagrammatic structure of a network enabling the implementation of the invention method, multimedia messages are sent, from a first mobile terminal 3, and via a first central data server 1 and links 9, 10, 19 and 20, to a second terminal mobile 4. The links 9, 10, 19 and 20 are for example WAP type links, i.e. links enabling the transport of multimedia message data. It is clear that more than two mobile terminals, either senders or receivers of multimedia messages, can be networked to communicate with the first server 1. It is also clear that the network can comprise several type 1 servers that can intercommunicate. Multimedia messages, at the time of their transport between terminals, transit advantageously by type 1 servers, called MMS-C (MMS-Centers), capable of managing exchanges and the temporary archiving of these multimedia messages. These servers are used by the operators of messaging services. The duration of the temporary archiving in the server 1 is for example 24 hours, or even several days; once this time has expired, the messages are automatically destroyed, so as not to monopolize the storage capacity in the server. The first server 1, MMS-C type, enables communication to be managed between the terminals 3 and 4. The server 1 comprises in particular a storage means 15, and a client or user data. base 16, also called DB1 (Data Base 1). The storage means 15 enables the temporary saving or archiving of one or more multimedia messages sent for example by the terminal 3. The user data base 16 contains data specific to the terminals 3 or 4 which communicate messages. In the preferred embodiment of the invention method, these data are essentially a recipient's address, or other data characterizing for example the sender of a message. The first server 1 comprises a transcoding means or transcoder 17. The transcoder 17 enables a conversion of the images received and stored in the storage means 15, when said images are sent to a recipient terminal; the transcoder 17 enables the adaptation of the image resolution to the display characteristics of the recipient terminal.

The temporary storage of multimedia messages, sent from the terminal 3, in the server 1, enables a recipient, not having a terminal 4 with sufficient storage capacity, to be uniquely notified on said terminal 4 first, for example by a message sent notification; that enables them to read said message on the terminal 4 later. The disadvantage of this temporary storage is that once the storage time programmed in the server 1 has expired, the message is destroyed, thus the addressed user can no longer read it on the terminal 4.

To eliminate the above-mentioned disadvantage leading to the destruction of the message before it is read, the invention method uses the storage capacity of a second data server 2. The second server 2 comprises a storage means 21, and a client or user data base 22, also called DB2 (Data Base 2). The storage means 21 enables the saving or archiving of one or more multimedia messages up to the moment when the recipient consults the multimedia messages on the terminal 4. The second server 2 thus enables the storage of the multimedia messages for an undetermined period. The user data base 22 (DB2) contains data specific to the terminals communicating the messages, data that are analog to and synchronized (i.e. simultaneously refreshed) with the data of the data base 16 (DB1) of the first server 1. In the preferred embodiment of the invention method, the data of the data base 16 are essentially a recipient's address an identifier of the recipient's subscription to a service, or other data characterizing for example the sender of a message. According to the envisioned embodiment of the invention, the two data servers 1 and 2 are located in two separate servers, or they are located in one and the same server.

In a first embodiment, the invention method enables the communication of at least one multimedia message, the message being sent from the first terminal 3, and intended to be sent to the second terminal 4. The communication is provided by the links 9, 10, 19 and 20. The link 19 between the two data servers 1 and 2 enables in particular to transport the data exchanged between the storage means 15 and 21 on the one hand, and between the data bases 16 and 22 on the other hand. The link 19 advantageously uses a specific communication protocol, API type (Application Programming Interface), also called proprietary protocol. The terminal 4 is identified for example by an encoded recipient's address. The invention method enables the automatic synchronization of the communication of multimedia messages between the two servers 1 and 2. The multimedia message being sent, from the first terminal 3, the contents of said multimedia message is temporarily saved, for example for a few days, in the storage means 12 of the first server 1. The software of the invention method determines if the recipient terminal is subject to a subscription to an archiving service. The archiving service is specific to the second server 2, i.e. a subscription identifier to this archiving service is recorded in the data base 22 of the server 2, said data base 22 being advantageously synchronized with the data base 16 of the server 1. In an advantageous embodiment, the invention method determines, from the data base 16 of the first server 1, if the recipient terminal is subject to a subscription to the archiving service. In another embodiment in which the data bases of the two servers 1 and 2 are not synchronized, the invention method determines if the recipient terminal is subject to a subscription to the archiving service, by communicating with the data base of the second server 2. If the recipient subscribes to the archiving service specific to the server 2, the software of the invention method automatically associates the multimedia message recipient's address with the subscription identifier to said archiving service. Then, the contents of the multimedia message are automatically sent from the temporary storage means 15 of the server 1, to the storage means 21 of the server 2. The invention method then operates, from receipt of the multimedia message on the server 2, the automatic archiving of the contents of said message in the storage means 21 of the server 2. The multimedia message can thus be archived without depending on a preset period at the end of which it is destroyed. The contents of the multimedia message sent comprise at least one digital image, at least one text element, and at least one audio partition. Advantageously the digital image is in color, and the audio partition is for example a melody.

In one variant of the previous embodiment, the invention method performs, before the archiving of the contents of the multimedia message in the server 2, an automatic extraction of a part of the contents of this message. According to the envisioned embodiment, the extraction is performed just before the archiving step, either from the first server 1, or from the second server 2. The extraction is performed by applying the special instructions of the software implementing the invention method. These special instructions enable the extraction of one or more images of a multimedia message comprising several images. These special instructions enable the extraction of one or more text elements contained in the multimedia message, or even the extraction of a part of the data forming tie audio partition of the multimedia message.

In an advantageous embodiment, the invention method performs the automatic reformatting of the multimedia message archived in the second server 2, to enrich the multimedia message with additional data, before sending the reformatted multimedia message to the second terminal 4. These additional data come from either the server 1, or the server 2; they are automatically incorporated into the multimedia message by the server 1. In this particular embodiment, the user of the terminal 4 subscribes, for example on the Internet, to a specific archiving service that enables the incorporation of these additional data. The additional data are for example, a dynamic link corresponding to a user account of said subscriber. The additional data can also comprise an automatic notification giving the information that the archiving of the multimedia message is performed on the second server 2. The additional data can for example comprise geolocation information, or any other information intended to enrich the contents of the multimedia message. In another variant of the embodiment, the user of the recipient terminal 4 can also use a dynamic link to perform a request for confirmation of the archiving in the server 2. In a variant of this last embodiment, the dynamic link to perform the request for confirmation of archiving also performs an automatic billing of the archiving with the recipient's archiving service.

While the invention has been described with reference to its preferred embodiments, it is clear that variants and modifications can be produced within the scope of the claims. Accordingly, such embodiments are for illustration only and are not considered to restrict the claimed protection.

What is claimed is:

1. A method enabling the communication of at least one multimedia message between at least two terminals (3), (4) located in a digital network comprising a first data server (1) and a second data server (2), each data server (1), (2) comprising at least one user data base (16), (22) and a digital data storage means (15), (21), said method being characterized in that it enables multimedia messages to be synchronized and archived between the two data servers by automatically performing the following steps:
a) from at least one multimedia message sent from a first terminal (3) and intended to be sent to a receiving address of a second terminal (4), the contents of said multimedia message being temporarily saved in the first server (1), determine a subscription identifier to a recipient's archiving service, the archiving service being specific to the second server (2);
b) associate the recipient's address with the subscription identifier to the archiving service of said recipient;
c) send the contents of the multimedia message from the first server (1) to the second server (2);
d) archive the contents of the multimedia message in the second server (2) for an undetermined period.

2. The method according to claim 1, wherein the contents of the multimedia message sent comprise at least one image, at least one text element, and at least one audio partition.

3. The method according to claim 1, wherein, before the archiving step, an automatic extraction is performed from a part of the contents of the multimedia message.

4. The method according to claim 3, wherein, before the archiving step, at least one image is extracted from the multimedia message.

5. The method according to claim 3, wherein, before the archiving step, at least one text element is extracted from the multimedia message.

6. The method according to claim 3, wherein, before the archiving step, one part of the data forming the audio partition is extracted from the multimedia message.

7. The method according to claim 3, wherein the extraction is performed from the first server (1).

8. The method according to claim 3, wherein the extraction is performed from the second server (2).

9. The method according claim 1, wherein the multimedia message archived in tile second server (2) is automatically reformatted to be enriched with additional data, before sending the reformatted message to the second terminal (4).

10. The method according to claim 9, wherein the additional data comprise a notification of archiving information of the multimedia message on the second server (2).

11. The method according to claim 9, wherein the additional data comprise a dynamic link to a user account of the recipient of the multimedia message.

12. The method according to claim 9, wherein the additional data comprise a dynamic link to perform an archiving confirmation request.

13. The method according to claim 12, wherein the dynamic link also enables an archiving automatic billing request to be performed.
